(19) United States
(12) Patent Application Publication
(10) Pub. No.: US 2002/0062480 A1
(43) Pub. Date: May 23, 2002

(54) Program updating system having communication function

(76) Inventor: Akihiro Kirisawa, Tokyo (JP)

Correspondence Address: WHITHAM, CURTIS & CHRISTOFFERSON, P.C., Suite 340, 11491 Sunset Hills Road, Reston, VA, 20190, US

(21) Appl. No.: 09/988,470

(22) Filed: Nov. 20, 2001

(30) Foreign Application Priority Data
Nov. 20, 2000 (JP) 352816/2000

(51) Int. Cl. G06F 9/445

(52) U.S. Cl. 717/168

(57) ABSTRACT

A program updating system having a communication function is composed of a first processor (1) that is operated by referring to a predetermined program and a second processor (2) which executes update of the program by using the communication function and then executes an update control of the program when a fault of the first processor (1) is detected. Thus, it is possible to provide the program updating system having the communication function, which can surely execute a program transfer, even if a fault is induced in the program to be updated.

### BACKGROUND OF THE INVENTION

1. Field of the Invention

The present invention relates to a program updating system having a communication function that can update a program by using the communication function.

2. Description of the Related Art

A program such as a firmware, which is referred to by a processor (CPU), is updated in order to cope with a bug or a change of a specification. For example, when a communication apparatus including the processor is composed of an outdoor apparatus installed in an outdoor and an indoor apparatus installed in an indoor, a firmware referred to by the processor installed in the outdoor apparatus is updated by using a communication function of executing a communication between the indoor apparatus and the outdoor apparatus. A new firmware is prepared on the indoor apparatus in order to update the firmware in the communication apparatus. The new firmware prepared on the indoor apparatus is transferred from the indoor apparatus to the outdoor apparatus. The new firmware received by the outdoor apparatus is stored in a memory medium such as a flash ROM and the like referred to by the processor. After the completion of the operations for transferring and storing the new firmware, restart of the communication apparatus is executed. This execution of the restart causes the communication apparatus, namely, the processor in the outdoor apparatus to be operated by referring to the new firmware.

An invention according to a technique of using a communication function and then updating a firmware is disclosed in Japanese Laid Open Patent Application (JP-A-Heisei 9-258976). In the invention disclosed in this JP-A-Heisei 9-258976, two flash ROMs are used as a memory medium for storing the firmware. The processor, by referring to the firmware stored in one flash ROM, stores a new firmware received by using a communication function in the other flash ROM. After the new firmware is stored, the processor executes a setting to refer to the other flash ROM, and restarts itself. After that, the processor operates by referring to the other flash ROM.

In the conventional technique, if the received or downloaded new firmware has a fatal bug which has an influence on a communication line, there may be a fear that it can be never downloaded after a time of a rise of the firmware including the fatal bug. Also, such a case may be induced when an erroneous program is transmitted or when the firmware is not written at all. Moreover, in a case of an employment of a two-CPU configuration composed of a main CPU and a local CPU shown in FIG. 5 of Japanese Laid Open Patent Application (JP-A-Heisei 9-258976), the firmware of the main CPU can not be re-written. As a result, the communication command and the like can not be changed. In this case, if the firmware for the main CPU is installed on the outdoor apparatus, a situation is induced in which the outdoor apparatus must be detached in order to update the firmware.

Japanese Laid Open Patent Application (JP-A-Heisei 10-133958) discloses “COMMUNICATION APPARATUS CONTROL CIRCUIT”. This communication apparatus control circuit employs a method of storing a main program for an apparatus control in an electrically erasable writable flash memory. This communication apparatus control circuit comprises a reset counter for detecting that a CPU can not be recovered by a watch dog reset of the CPU and a system error detector. The communication apparatus control circuit further includes an address decoder, which when a system error is detected by the system error detector, compulsorily switches a memory region accessed by the CPU, to a spare memory region in which a down line load function program and a function program to be operated at a time of a spare operation are stored and RAM and ROM for storing the spare program constituting the spare memory region. Due to this configuration, even if the CPU is run away and it can not be recovered by the watch dog reset, the switching to the spare memory region for the processing operation through the spare program enables the down line load of the main program. Thus it is not necessary to exchange a memory device.

### SUMMARY OF THE INVENTION

An object of the present invention is to provide a program updating system having a communication function, which even if a fault is induced in a program such as a firmware or the like to be updated, can surely transfer that program.

Means for achieving the object will be described below using reference numerals and symbols used in “Embodiments of the invention”. These reference numerals and symbols are added so that relation between the description of “Scope of the Patent to be claimed” and the description of “Embodiments of the invention” is made clear. However, it is never permitted to use the reference numerals and symbols for the interpretation of technical scopes of the inventions described in “Scope of the Patent to be claimed” and the description of “Embodiments of the invention”.

A program updating system having a communication function according to a first aspect of the present invention is comprises a first processor (1) which operates by referring to a program stored therein and a second processor (2) which executes update of the program by using the communication function with an external unit, and executes an update control of the program when a fault of the first processor (1) is detected.

In this program updating system having the communication function according to the first aspect of the present invention, the second processor (2) may transmit a reset signal (Pr) to the first processor (1) for every predetermined cycles, and then monitor a response pulse (Pa) which is transmitted from the first processor (1) in response to the reset signal (Pr), and further transmit a compulsory reset signal (La:Low) to the first processor (1) when the response pulse (Pa) can not be detected within a predetermined period (corresponding to T2, T3, T4 and T5, or T2, T4, T5 and T7).

The program updating system having the communication function according to the first aspect of the present invention may further include an activation pulse generating circuit (3) for generating an activation pulse (P1) to activate the second processor (2). In this configuration, the second processor (2) starts transmitting of the reset signal (Pr) in response to the activation pulse (P1) outputted from the activation pulse generation circuit.

The program updating system having the communication function according to the first aspect of the present invention may further include an activation monitoring circuit (13) which generates an activation pulse (corresponding to the P1) to activate the second processor (2), and then monitors transmission of an activation response pulse (corresponding to the Pr) which is outputted from the second processor (2) in response to the activation pulse. In this configuration, the activation monitoring circuit (13) transmits a compulsory reset signal to the second processor (2) when the activation response pulse can not be detected within the predetermined period.

In the program updating system having the communication function according to the first aspect of the present invention, the second processor may further include a buffer (14a) which transiently stores the program for executing the update control. In this configuration, the second processor (2) transfers the program stored in the buffer (14a) to the first processor (1) after an operation of storing the program in the buffer (14a) is completed.

In a program updating method having a communication function according to a second aspect of the present invention, a first processor (1) operated by referring to a program stored therein and a second processor (2) are provided. The second processor (2) transmits a reset pulse to the first processor (1). The first processor (1) transmits a response pulse (Pa) to a second processor (2) in response to a reset signal (Pr) which is outputted from the second processor (2). Then, the second processor (2) transmits a compulsory reset signal to the first processor (1) when the response pulse (Pa) can not be detected within a predetermined period, and it stops the operation of the first processor (1).

In the program updating method using the communication function according to the second aspect of the present invention, the second processor (2) may transfer the program obtained by using the communication function to the first processor (1) during a stop of the first processor (1).

The program updating method using the communication function according to the second aspect of the present invention may further be provided an activation control circuit (13) which controls activation and a stop of said second processor (2). The second processor (2) transmits an activation response pulse (corresponding to the Pr) to an activation control circuit (13) for every predetermined cycles. The activation control circuit (13) executes a stop control of the second processor (2), when the activation response pulse (corresponding to the Pr) can not be detected within a predetermined period (corresponding to T2, T3, T4 and T5, or T2, T4, T5 and T7).

### BRIEF DESCRIPTION OF THE DRAWINGS

FIG. 1 is a conceptual view of an outdoor apparatus according to an embodiment of the present invention;

FIG. 2 is a circuit diagram of a processor circuit shown in FIG. 1;

FIG. 3 is a first timing chart according to the embodiment of the present invention;

FIG. 4 is a second timing chart according to the embodiment of the present invention;

FIG. 5 is a third timing chart according to the embodiment of the present invention;

FIG. 6 is a fourth timing chart according to the embodiment of the present invention;

FIG. 7 is a timing chart of a program updating process according to the embodiment of the present invention;

FIG. 8 is a conceptual view of a first variation according to the embodiment of the present invention;

FIG. 9 is a conceptual view of a second variation according to the embodiment of the present invention; and

FIG. 10 is an explanatory diagram of an operation of a third variation according to the embodiment of the present invention.

### DESCRIPTION OF THE PREFERRED EMBODIMENTS

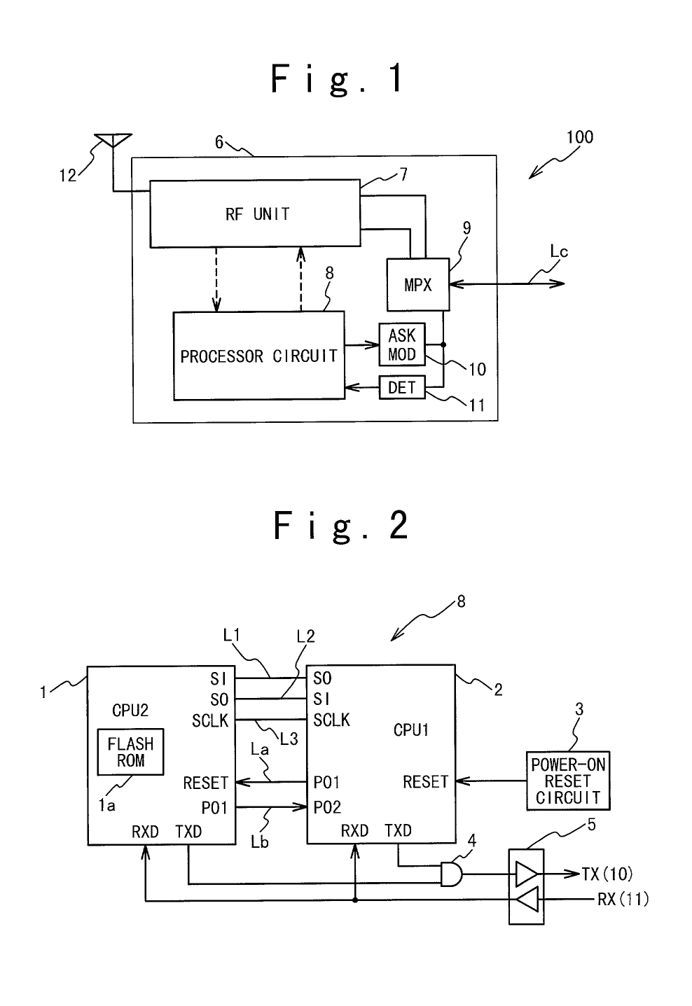

FIG. 1 is a conceptual view of an outdoor apparatus according to an embodiment of the present invention. An outdoor apparatus 100 shown in FIG. 1 includes a signal processor 6 and an antenna 12. The signal processor 6 is composed of a high frequency unit (RF unit) 7, a processor circuit 8, a multiplexer 9, a modulator (ASK MOD) 10 and a detector (DET) 11.

The signal processor 6 is connected through a communication cable Lc to an outdoor apparatus (not shown).

The high frequency unit 7 controls an amplification of a radio signal and a frequency conversion. The processor circuit 8 controls a monitor of an alarm, a gain control, a frequency setting and the like. The multiplexer 9 controls a multiplexing between the radio signal and a data. The modulator 10 generates a modulation wave to be transmitted to a communication cable Lc. The detector 11 controls a demodulation of the modulation wave inputted from the communication cable Lc.

FIG. 2 is a circuit diagram of the processor circuit 8 shown in FIG. 1. The processor circuit 8 is composed of a first processor (CPU2) 1, a second processor (CPU1) 2, a power-on reset circuit 3, a gate circuit 4 and a communication buffer 5. The first processor 1 has a flash ROM 1a. Lines L1 to L3 and A line La and B line Lb are laid between the first processor 1 and the second processor 2. The modulator 10 and the detector 11 are connected to the communication buffer 5.

The second processor 2 executes a transfer control of a program that is referred to by the first processor 1. The first processor 1 executes an operational control in the signal processor 6 by referring to a program stored in the flash ROM 1a.

The lines L1 to L3 are the signal lines used to store the program in the flash ROM 1a. The A line La is used to transfer a reset signal to the first processor 1 from the second processor 2. The B line Lb is used to transfer a response pulse to the second processor 2 from the first processor 1.

An asynchronous serial interface (UART) (not shown) is built in each of the second processor 2 and the first processor 1. The asynchronous serial interface is connected to two lines (TXD, RXD) for transmission and reception. Those lines are connected through the gate circuit 4 or directly to the communication buffer 5.

When the power-on reset circuit 3 is activated, a power-on reset operation is performed on the second processor 2, on the basis of a power-on reset pulse outputted from the power-on reset circuit 3. Accordingly, the second processor 2 is activated. The second processor 2 transmits the response signal after the activation, and thereby activates the first processor 1. After the activation, the first processor 1 and the second processor 2 monitor the reception lines (RXDs), respectively. When a control command of the signal processor 6, for example, a monitor control command is transmitted to the reception line, the first processor 1 receives the control command. When an instruction command for a program transfer is transmitted to the reception line, the second processor 2 receives the instruction command and starts a program transfer process. It should be noted that the transmission line (TXD) on the side of the second processor 2 is usually fixed to a HIGH level, and the content of the transmission line on the side of the first processor 1 is transmitted to the modulator 10. On the other hand, when an instruction of the program transfer is generated, the transmission line on the side of the first processor 1 is fixed to the HIGH level, and the content of the transmission line on the side of the second processor 2 is transmitted to the modulator 10. Hence, the transmission data transmitted by each processor is transmitted through the gate circuit 4 to the modulator 10 without any interference.

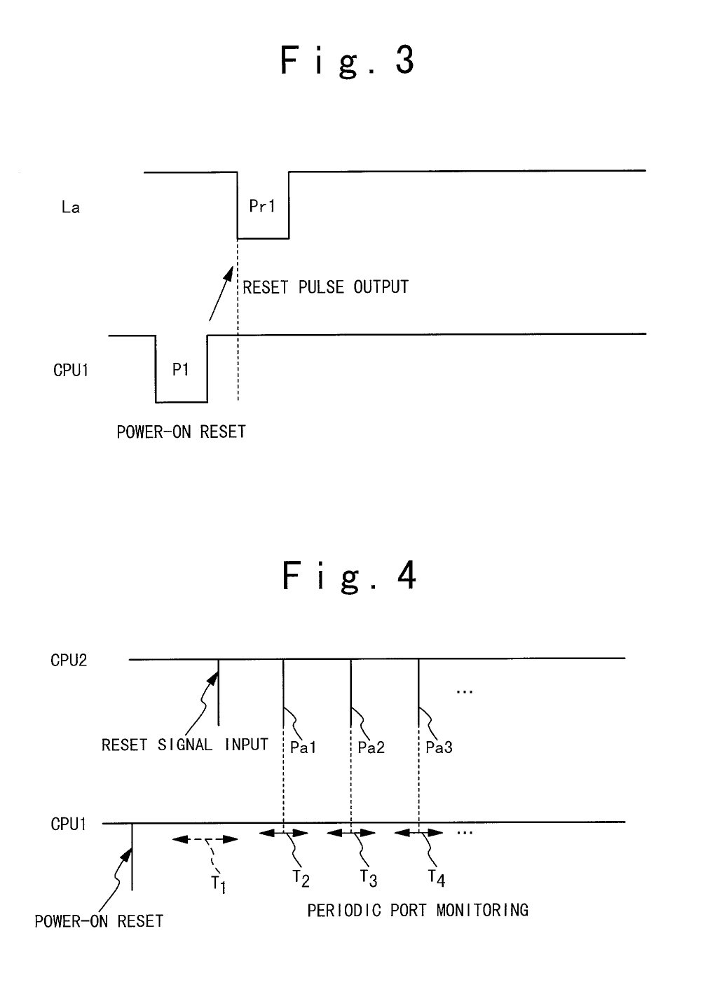

The operations of the processor circuit 8 having the above configuration will be described below with reference to FIGS. 3 to 7. FIG. 3 is a first timing chart according to the embodiment of the present invention. When the power-on reset circuit 3 is activated, the second processor 2 receives a power-on reset pulse P1 from the power-on reset circuit 3. The second processor 2 transmits a reset signal Pr1 to the A line La, in response to the power-on reset pulse P1. The first processor 1 is activated by the reception of the reset signal Pr1. After that, the first processor 1 executes an operational control of the signal processor 6 by referring to the content of the flash ROM 1a. On the other hand, the second processor 2 enters into a waiting state for waiting an instruction of a program update.

The first processor 1 transmits a response pulse (Pa) having a low level to the B line Lb, for example, at a cycle of 100 ms after the activation. This response pulse is used in the second processor 2 for judging a state of the first processor 1.

FIG. 4 is the second timing chart according to the embodiment of the present invention. The second processor 2 receives the power-on reset pulse, and waits for transmission of the reset signal and an elapse of a wait period (monitor inhibition period) T1. After that, the second processor 2 monitors the transmission of the response pulse according to the monitor periods (T2, T3, T4, . . . ). The first processor 1, in a case of a normal operation, transmits response pulses Pa1, Pa2, Pa3, . . . , to the second processor 2, for example, at a cycle of 100 ms, namely, at a timing corresponding to the monitor period. The second processor 2 can detect the response pulse during the monitor period to thereby detect a normal operation state of the first processor 1. While detecting the normal operation state of the first processor 1, the second processor 2 keeps a level of the A line La at the HIGH level, and allows the operation of the first processor 1. It should be noted that the wait period T1 is set, for example, by considering a time while the first processor 1 is shifted to a stable operation state on the basis of the reset signal.

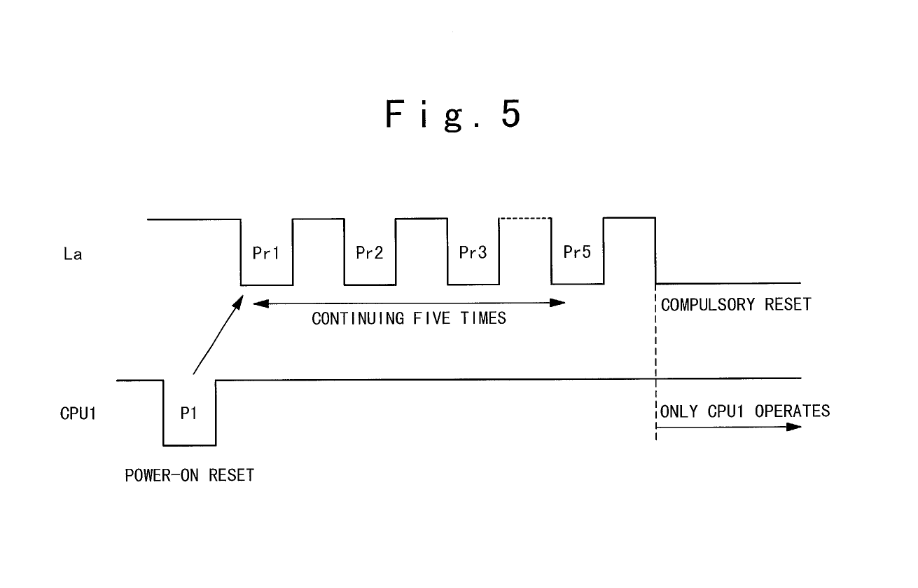

A case of an occurrence of a fault in the first processor 1 will be described below with reference to FIG. 5. FIG. 5 is a third timing chart according to the embodiment of the present invention. It is assumed that an erroneous program (HEX data) including a bug is stored in the flash ROM 1a of the first processor 1. In such a case, the first processor 1 becomes unstable in operation. Thus, the first processor 1 can not generate the response pulse at the predetermined timing.

As shown in FIG. 5, the second processor 2 again transmits the reset signal to the A line La if the response pulse can not be detected within the monitor period. The reset operation based on this reset signal causes the first processor 1 to be again activated. However, a pulse (response pulse) having the LOW level can not be transmitted to the B line Lb. The second processor 2 further transmits the reset signal if the response pulse can not be detected again within the monitor period. When such operations are repeated, for example, five times, namely, after the elapse of the fifth monitor period, the second processor 2 judges that a firmware installed in the first processor 1 is not normal, and the second processor 2 compulsorily resets the first processor 1.

The above process explained with FIG. 5 will be actually described. After the second processor 2 is activated in response to the power-on reset pulse, the second processor 2 transmits the power-on reset pulse (activation pulse) P1 to the first processor 1. If the second processor 2 can not detect the response pulse (Pa) transmitted from the first processor 1 within the monitor period (see FIG. 3), the second processor 2 transmits the reset signals Pr1, Pr2, . . . to the A line La every end of the monitor period. If the second processor 2 can not detect the response pulse to be transmitted from the first processor 1, for example, until the elapse of the monitor period corresponding to the fifth reset signal Pr5, the second processor 2 judges that the first processor 1 is at an abnormal operation state, and sets the A line La to the low level state. If the A line La is kept at the low level state, the first processor 1 is set to a compulsory reset to stop the operation. This setting of the low level state implies the transmission of the compulsory reset signal.

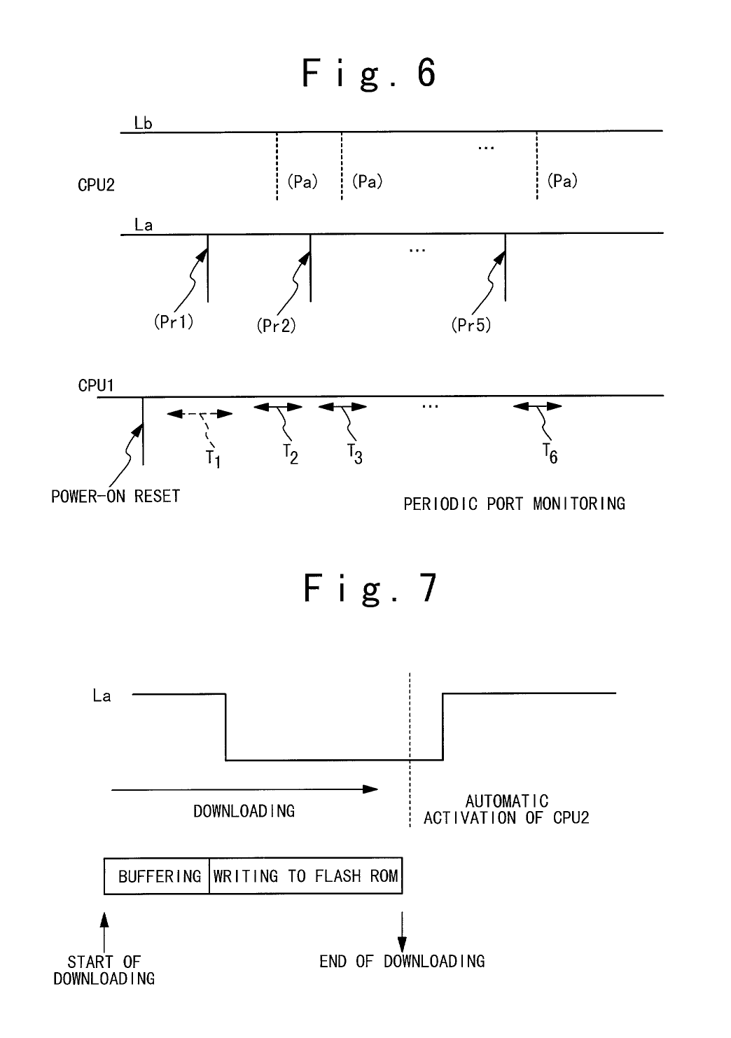

FIG. 6 is a fourth timing chart according to the embodiment of the present invention. When the fault is occurred, the first processor (CPU2) 1 can not generate the response pulse (Pa) to be transmitted to the B line Lb, even if receiving the reset signal (Pr) transmitted to the A line La from the second processor (CPU1) 2. As indicated by dotted lines of FIG. 6, the timing that the response pulse (Pa) is transmitted to the B line Lb corresponds to the monitor period. If the second processor 2 executes a fault operation judgment correspondingly to five reset signals Pr, the A line La continues to be set at the low level after the elapse of the fifth monitor period T6. The first processor 1 stops the operation if the A line La continues to be set at the low level.

In the above-mentioned processes, the reset signal (Pr) performs an action similar to an operation clock (watch dog timer clock) on the first processor 1.

It should be noted that the process for carrying out the fault judgment of the first processor 1 by referring to the five reset signals (Pr) transmitted from the second processor 2 is carried out to avoid the fault of the first processor 1 from being erroneously judged because of the influence of noise and the like. That number is not especially limited to 5.

While the first processor 1 controls the monitor operation, the second processor 2 monitors the transmission of the response pulse (Pa) until a program transfer command (download command) is received, and it does not execute the other operations at all. The first processor 1 transmits the response pulse (Pa) having the LOW level to the B line Lb every period of 100 ms after the activation. The second processor 2 monitors the transmission of the response pulse (Pa) on the basis of a state of a port. Then, the second processor 2 continues to keep the A line La at the HIGH level if the response pulse can be detected.

The ASYNC signal lines for the receptions (RDXs of FIG. 1) are connected in parallel. Therefor, the first processor 1 and the second processor 2 receive the same data. Each processor monitors the reception data. If the reception data is the monitor control command, the first processor 1 is operated. In the case of the download command, the second processor 2 is operated. The ASYNC signal lines for the transmission (TXD of FIG. 1) are connected to a gate circuit 4. If only one processor transmits a data, the line TXD is fixed to the HIGH level. The ASYNC signal line for the transmission of the second processor 2 is usually set at the HIGH level since the second processor 2 carries out a communication only when the download command is transmitted. Thus, the first processor 1 can avoid a signal collision and carry out a communication. When the download command is transmitted, the second processor 2 firstly stores the data in a buffer. Meanwhile, the first processor 1 does not carry out the ASYNC communication, and only the second processor 2 carries out the communication.

Next, the second processor 2 makes the first processor 1 hold the reset state, and writes a new firmware to a flash ROM by using a three-line type flash write line (SI, SO and SCLOC). This state can be set, for example, if a program does not exist in the flash ROM 1a, namely, if update of a program is failed.

When an abnormal firmware is written, the first processor 1 can not transmit the response pulse having the LOW level to the B line Lb since the firmware is not normal after the activation. The second processor 2 monitors the response pulse through the port. If the second processor 2 can not detect the response pulse, it again transmits the reset signal to the A line La. This reset signal causes the first processor 1 to be again activated. However, since the first processor 1 can not transmit the response pulse to the B line Lb, the reset signal is again transmitted. When this operation is repeated five times, the second processor 2 judges that the firmware of the first processor 1 is not normal, and compulsorily resets the first processor 1 (refer to FIG. 4). The reason why the reset operation is repeated five times at this time is to avoid the processor from becoming at the compulsory reset state, when the noise or the like causes the processor to carry out an erroneous operation, even if the normal firmware is written. If the process carries out the erroneous operation in the condition that the normal firmware is written, the process is recovered by one reset operation, and it is returned back to the normal operation. In this case, the second processor 2 carries out an operation similar to that of the so-called watch dog timer. Since the first processor 1 is compulsorily reset, the ASYNCE line for the transmission (TXD) connected to the first processor 1 is set at the HIGH level. Thus, the second processor 2 can normally carry out a communication. Hence, even if the abnormal firmware is written, the normal firmware can be again downloaded. This is similar in a case that the flash ROM is empty at an initial state. If the processor is activated when the flash ROM is empty, the firmware is run away, which may have an influence on a communication line. However, since the first processor 1 is compulsorily reset, it is possible to set the downloadable state.

The operation of the program updating process executed under the control of the second processor 2 will be described below with reference to FIG. 7. FIG. 7 is a timing chart of the program updating process according to the embodiment of the present invention. The second processor 2, when receiving a new program through a gate of the communication buffer 5, issues a program transfer instruction through the gate of the communication buffer 5. A program supply source receiving this instruction prepares a program to be transmitted, namely, executes a buffering. After the completion of the preparation, the program supply source reports a transmission instruction to the second processor 2. Meanwhile, the second processor 2 keeps the level of the A line La at a standard level (low level).

The second processor 2 receiving the transmission instruction sets the level of the A line La to the LOW level, and reports the writing to the flash ROM 1a to the first processor 1. Moreover, the second processor 2 instructs the program supply source to transmit the program. The second processor 2, when receiving the program, transfers the program through the lines L1 to L3 to the first processor 1. The first processor 1 writes the transferred program in the flash ROM 1a.

The second processor 2 sets the level of the A line La to the standard level after the completion of the writing of the program. The first processor 1, when detecting a change of the level in the A line La, executes the operational preparation with reference to the new program on the flash ROM 1a, and then monitors the transmission of the reset signal generated in the second processor 2. After that, the operations are carried out in the cycle explained with reference to FIG. 4.

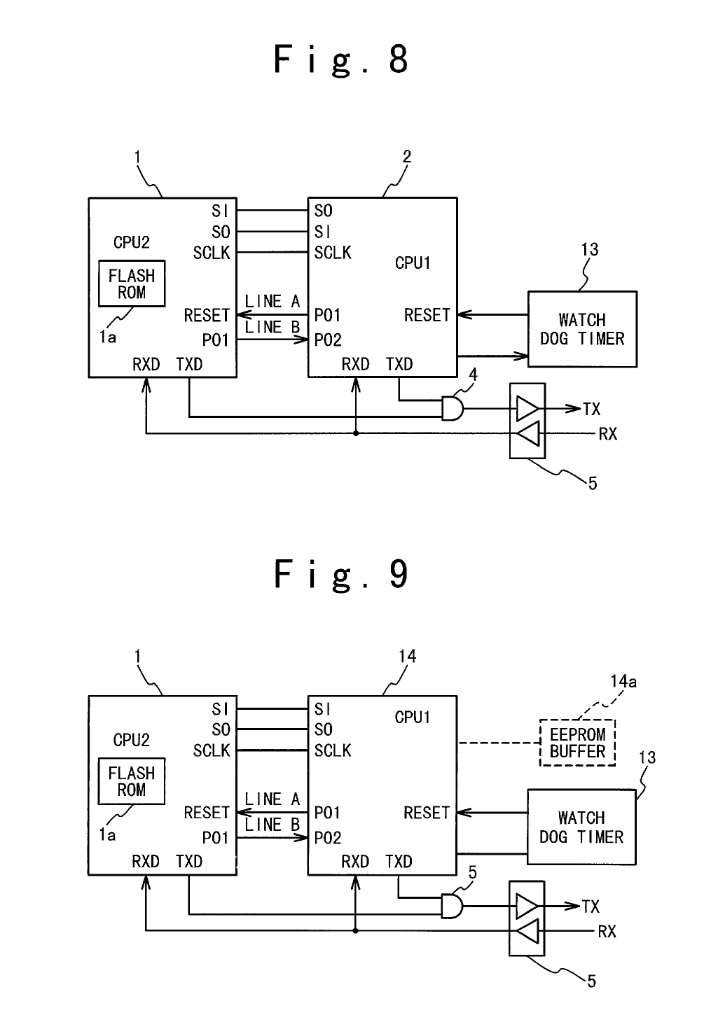

Variations according to the embodiment of the present invention will be described below with reference to FIGS. 8 to 10. FIG. 8 is a conceptual view of a first variation according to the embodiment of the present invention. A watch dog timer 13 is installed in the processor circuit 8 shown in FIG. 8, instead of the power-on reset circuit 3 of the processor circuit shown in FIG. 1. The watch dog timer 13 transmits an activation pulse to the second processor 2. In the watch dog timer 13, a timeout is not induced if a watch dog pulse can be detected. For this reason, a level of a reset terminal of the second processor 2 is kept at the high level, and operations of the second processor 2 are allowed. If the watch dog pulse can not be detected, the watch dog timer 13 judges that a fault occurs in the second processor 2. Then, the compulsory reset signal, for example, the level of the reset terminal of the second processor 2 is set at the low level. This setting causes the second processor 2 to stop the operation. If the second processor 2 stops the operation, the level of the A line La is also set at the low level. As a result, the compulsory reset signal is transmitted to the first processor 1.

Due to the above-mentioned configuration, it is possible to monitor the fault of the second processor 2, namely, the operation stop in association with the fault occurrence, in addition to the fault monitor of the first processor 1.

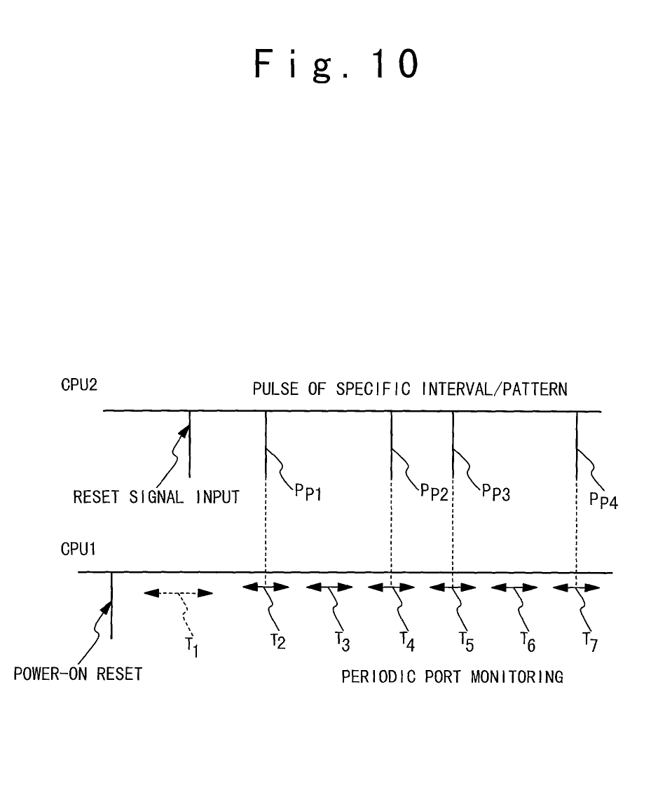

FIG. 9 is a conceptual view of a second variation according to the embodiment of the present invention. A processor circuit 8 shown in FIG. 9 differs from the processor circuit shown in FIG. 8 in that a buffer 14a is installed in a second processor 14. This buffer 14a is composed of EEPROM and the like, and it can transiently store the program transmitted from the program supply source. The second processor 14 does not transmit the received program to the lines L1 to L3 simultaneously with the reception, and once stores the entire program in the buffer 14a. After the success in the storing to the buffer 14a, the second processor 14 executes a program transfer to write the program to the flash ROM 1a.

Due to the execution of the transfer procedure of the two stages as mentioned above, for example, in a case of a failure of a program transfer to the flash ROM 1a, it is possible to again avoid the program transfer process in which all of the program supply source, the second processor 14 and the first processor 1 participate. That is, in the case of the failure of the writing to the flash ROM 1a, it is enough to refer to the program buffered in the buffer 14a to then execute the program transfer process only between the first processor 1 and the second processor 14.

FIG. 10 is an operational explanation view of a third variation according to the embodiment of the present invention. In the above-mentioned configuration, the fault is detected in accordance with the presence or absence of the response pulse based on the reset signal generated at the constant cycle. In the third variation, the response pulse is generated at a cycle of a predetermined pattern. For example, the second processor 14 transmits the reset signals Pr1, Pr2, Pr3, . . . at the timings illustrated in FIG. 5. On the other hand, the first processor 1 generates first to fourth response pattern pulses Pp (Pp1 to Pp4) in response to the timings of the first, third, fourth and sixth reset signals Pr1, Pr3, Pr4, Pr6, . . . . For this reason, the second processor 2 monitors the generations of the first to fourth response pattern pulses Pp (Pp1 to Pp4) corresponding to the monitor periods T2, T4, T5 and T7. That is, during the first processor 1 is under the normal operation, the reset signal is generated in a content of “1111 . . . ”, and the response pulse is generated in a content of “101101 . . . ”. By setting a generation pattern to the response pulse as mentioned above, it is possible to avoid the erroneous detection of the abnormal operation caused by the noise and the like and the normal operation. Also, the response pulse is normally transmitted because it is generated in the timer process. However, a timing calculation process is required in order to generate the transmission pattern. Thus, this is effective in a case that a bug is present in another operational portion in relation to the calculating process.

The program updating system having the communication function according to the present invention includes the second processor for controlling the update of the program and the first processor for executing the other processes, which is targeted for the update of the firmware. If the first processor can not carry out the normal response within the predetermined period for the action from the second processor, the operation of the first processor is compulsorily stopped. Thus, it is possible to avoid the fault caused by the runaway operation of the first processor. Moreover, even in the case of the stop of the operation of the first processor, the process for updating the firmware can be executed under the control of the second processor.

What is claimed is:

1. A program updating system having a communication function comprising:
a first processor which operates by referring to a program stored therein; and
a second processor which executes update of said program by using said communication function with an external unit, and executes an update control of said program when a fault of said first processor is detected.

2. The program updating system having the communication function according to claim 1,
wherein said second processor transmits a reset signal to said first processor for every predetermined cycles, and monitors a response pulse which is transmitted from said first processor in response to said reset signal, and transmits a compulsory reset signal to said first processor when said response pulse can not be detected within a predetermined period.

3. The program updating system having the communication function according to claim 2, further comprising:
an activation pulse generating circuit which generates an activation pulse to activate said second processor,
wherein said second processor starts transmitting of said reset signal in response to said activation pulse outputted from said activation pulse generating circuit.

4. The program updating system having the communication function according to claim 3, further comprising:
a buffer which transiently stores said program for executing said update control,
wherein said second processor transfers said program stored in said buffer to said first processor, after an operation of storing said program in said buffer is completed.

5. The program updating system having the communication function according to claim 1, further comprising:
an activation pulse generating circuit which generates an activation pulse to activate said second processor,
wherein said second processor starts transmitting of said reset signal in response to said activation pulse outputted from said activation pulse generating circuit.

6. The program updating system having the communication function according to claim 5, further comprising:
a buffer which transiently stores said program for executing said update control,
wherein said second processor transfers said program stored in said buffer to said first processor, after an operation of storing said program to said buffer is completed.

7. The program updating system having the communication function according to claim 1, further comprising:
a buffer which transiently stores said program for executing said update control,
wherein said second processor transfers said program stored in said buffer to said first processor, after an operation of storing said program to said buffer is completed.

8. The program updating system having the communication function according to claim 2, further comprising:
an activation monitoring circuit which generates an activation pulse to activate said second processor and monitors transmission of an activation response pulse which is outputted from said second processor in response to said activation pulse,
wherein said activation monitoring circuit transmits a compulsory reset signal to said second processor when said activation response pulse can not be detected within the predetermined period.

9. The program updating system having the communication function according to claim 8, further comprising:
a buffer which transiently stores said program for executing said update control,
wherein said second processor transfers said program stored in said buffer to said first processor, after an operation of storing said program to said buffer is completed.

10. The program updating system having the communication function according to claim 1, further comprising:
an activation monitoring circuit which generates an activation pulse to activate said second processor and monitors transmission of an activation response pulse outputted from said second processor in response to said activation pulse,
wherein said activation monitoring circuit transmits a compulsory reset signal to said second processor when said activation response pulse can not be detected within the predetermined period.

11. The program updating system having the communication function according to claim 10, further comprising:
a buffer which transiently stores said program for executing said update control,
wherein said second processor transfers said program stored in said buffer to said first processor, after an operation of storing said program to said buffer is completed.

12. A program updating method using a communication function, comprising:
providing a first processor which operates by referring to a program stored therein and a second processor,
transmitting a reset pulse from said second processor to said first processor;
transmitting a response pulse from said first processor to said second processor in response to said reset signal which is outputted from said second processor; and
transmitting a compulsory reset signal from said second processor to said first processor when said response pulse can not be detected within a predetermined period to stop an operation of said first processor.

13. The program updating method using the communication function according to claim 12, wherein said second processor transfers said program obtained by using said communication function to said first processor, during a stop of said first processor.

14. The program updating method using the communication function according to claim 13, further comprising:
providing an activation control circuit which controls activation and a stop of said second processor,
wherein said second processor transmits an activation response pulse to said activation control circuit for every predetermined cycles, and
said activation control circuit executes a stop control of said second processor, when said activation response pulse can not be detected within a predetermined period.

15. The program updating method using the communication function according to claim 12, further comprising:
providing an activation control circuit which controls activation and a stop of said second processor,
wherein said second processor transmits an activation response pulse to said activation control circuit for every predetermined cycles, and
said activation control circuit executes a stop control of said second processor, when said activation response pulse can not be detected within a predetermined period.
